(19) United States
(12) Patent Application Publication
(10) Pub. No.: US 2023/0180215 A1
(43) Pub. Date: Jun. 8, 2023

(54) METHOD, DEVICE, AND SYSTEM FOR SIDELINK RESOURCE SELECTION

(71) Applicant: ZTE Corporation, Shenzhen (CN)

(72) Inventors: Weiqiang DU, Shenzhen (CN); Wei Luo, Shenzhen (CN)

(73) Assignee: ZTE Corporation, Shenzhen (CN)

(21) Appl. No.: 18/104,535

(22) Filed: Feb. 1, 2023

Related U.S. Application Data
(63) Continuation of application No. PCT/CN21/92616, filed on May 10, 2021.

(51) Int. Cl. H04W 72/1263; H04W 76/28; H04W 72/50

(52) U.S. Cl. CPC H04W 72/1263; H04W 76/28; H04W 72/535

(57) ABSTRACT

This disclosure above describes a method, a device, and a system for sidelink communication. Performed by a first UE, the method includes initiating a sidelink data transmission session with a second UE which is running in a DRX mode; and selecting a first transmission resource within a first active time of the second UE for transmitting a first data packet of the sidelink data transmission session to the second UE. The disclosure describes various embodiments which support: sidelink transmission resource selection in DRX mode; sidelink transmission resource selection/re-selection; inter-UE coordination for transmission resource selection; logical channel prioritization; and assisting information reporting via shared transmission resource, etc.

### TECHNICAL FIELD

This disclosure is directed generally to wireless communications, and particularly to methods, systems and devices for sidelink communication.

### BACKGROUND

With the development of wireless multimedia services, demands for high data rates and user experience are increasing, which lead to higher requirements on wireless communication system capacity and coverage. On the other hand, application scenarios such as public safety, social networking, short-distance data sharing, and local advertising have gradually increased the demand for communication between nearby device. Therefore, the device-to-device (D2D) communication technology has emerged. The D2D technology can reduce the burden on the cellular network, reduce the battery power consumption of user equipment (UE), increase the data rate, and improve the robustness of the network infrastructure, which satisfies the requirements of high data rate services and proximity services. D2D technology is also referred to as Proximity Services (ProSe), or sidelink (SL) communication.

Reducing power consumption and increasing battery life in mobile devices is an important goal in designing sidelink communication. Reducing the operating time of UE hardware circuitry in sidelink communication yet still meet the service requirement can contribute significantly to such power savings.

### SUMMARY

This disclosure is directed to methods, systems and devices for sidelink communication.

In one embodiment, a method for sidelink communication in a wireless communication network is disclosed. Performed by a first UE, the method may include initiating a sidelink data transmission session with a second UE which is running in a Discontinuous Reception (DRX) mode; and selecting a first transmission resource within a first active time of the second UE for transmitting a first data packet of the sidelink data transmission session to the second UE.

In one embodiment, a method for sidelink communication in a wireless communication network is disclosed. Performed by a first UE, the method may include initiating a sidelink data transmission session with a second UE which is running in a DRX mode, the sidelink data transmission session being associated with a set of logical channels; determining a logical channel from the set of logical channels based on a predefined condition; and selecting a transmission resource for the sidelink data transmission session based on the logical channel.

In one embodiment, a method for sidelink communication in a wireless communication network is disclosed. Performed by a first UE configured with a pre-selected transmission resource in a transmission resource pool for supporting sidelink data transmission to a second UE, the method may include determining that the pre-selected transmission resource is no longer suitable for sidelink data transmission; and updating the pre-selected transmission resource with a transmission resource which is suitable for sidelink data transmission.

In one embodiment, a method for performing logical channel prioritization in sidelink communication, performed by a UE, the method may include determining that a destination UE is not in active time, the destination UE being running in a DRX mode; and skipping a logical channel associated with the destination UE when performing the logical channel prioritization.

In one embodiment, a method for sidelink communication in a wireless communication network is disclosed. Performed by a first UE, the method may include comprising initiating an inter-UE coordination to a second UE in response to at least one of following conditions being satisfied: a priority or a reliability requirement of a sidelink data to be transmitted being higher than a pre-configured threshold; a channel busy ratio of the first UE being higher than a pre-configured threshold; a number of discontinuous transmission to the second UE being higher than a pre-configured threshold; a number of Hybrid Automatic Repeat Request Negative Acknowledgement (HARQ NACK) received from the second UE being higher than a pre-configured threshold; the second UE supporting inter-UE coordination; a set of transmission resources for sidelink communication provided by the second UE being out of date; a transmission resource pool for sidelink communication being re-configured; a sensing parameter of the first UE being re-configured; or no transmission resource in the set of transmission resources for sidelink communication provided by the second UE being able to accommodate a maximum allowed Modulation Coding Scheme.

In one embodiment, a method for a first UE selecting a second UE as a destination UE during a logical channel prioritization procedure in sidelink communication, performed by the first UE configured with a transmission resource for sidelink data transmission, the method may include at least one of: in response to the transmission resource being in a set of preferred resources provided by the second UE, selecting the second UE as the destination UE; in response to the transmission resource being not in a set of non-preferred resources provided by the second UE, selecting the second UE as the destination UE; or in response to the transmission resource being not in a set of collide resources provided by the second UE, selecting the second UE as the destination UE.

In one embodiment, a method for sidelink communication in a wireless communication network is disclosed. Performed by a first UE, the method may include during a logical channel prioritization procedure of the sidelink communication, determining that there is enough capacity in a sidelink data transmission resource after data multiplexing; and adding transmission resource report in the sidelink data transmission resource, the transmission resource report being used for assisting a second UE for selecting sidelink data transmission resource; and transmitting the sidelink data transmission resource to the second UE.

In some embodiments, there is a wireless communication device comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an exemplary wireless communication network.

FIG. 2 shows various exemplary sidelink communication scenarios.

FIG. 3 shows a receiving User Equipment (RX UE) receiving sidelink data in Discontinuous Reception (DRX) mode.

FIG. 4 shows an exemplary transmission resource selection on Transmitting UE (TX UE) for transmitting sidelink data to an RX UE configured with an inactive timer.

### DETAILED DESCRIPTION

The following description and drawing set forth certain illustrative implementations of the disclosure in detail, which are indicative of several example manners in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings.

### Introduction

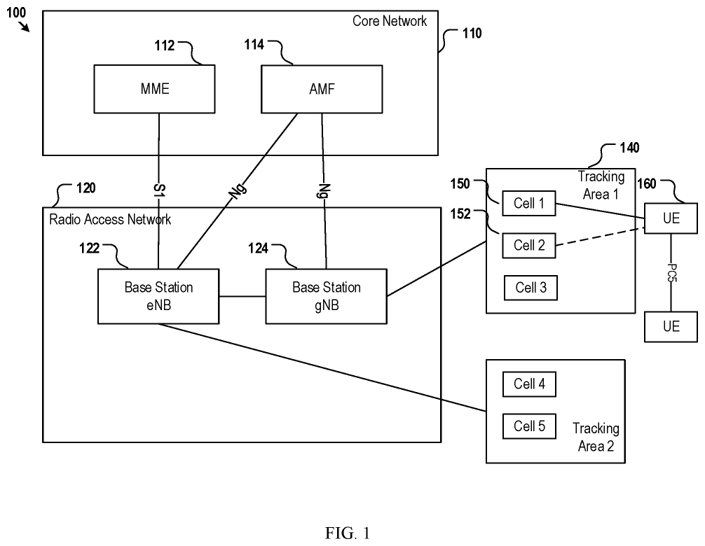

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, or a Next generation NodeB (gNB) for 5G New Radio (NR), or any other type of signal transmitting/receiving device such as a UMTS NodeB. The eNB 122 communicates with the MME 112 via an Si interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, and desktop computers. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

### Sidelink Communication

Sidelink communication is a communication mechanism in which cellular devices, such as UEs, IoT devices, Vehicles, and other type of wireless terminals, are able to communicate with each other directly without using the cellular network as a relay.

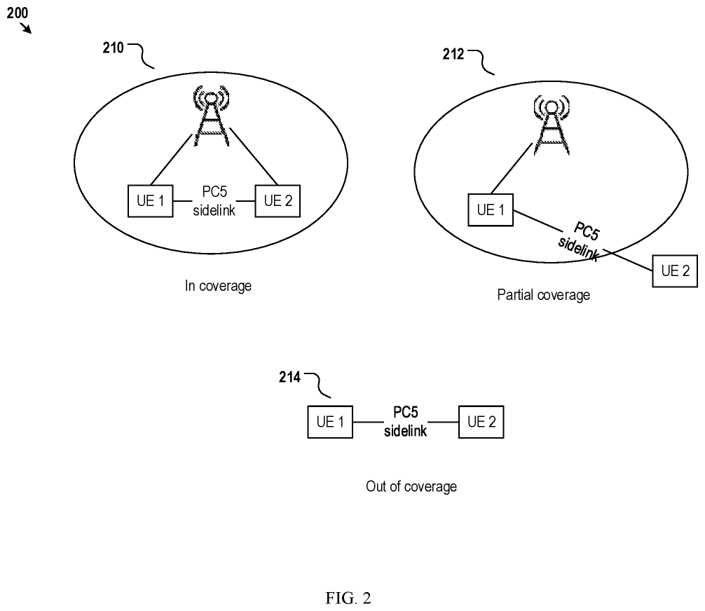

FIG. 2 illustrates various configurations for sidelink communication. Configuration 210 illustrates an “in coverage” configuration in which both UE 1 and UE 2 are under cellular coverage. Configuration 212 illustrates a “partial coverage” configuration in which only UE 1 is under cellular coverage. Configuration 214 illustrates an “out of coverage” configuration in which none of UE 1 or UE 2 is under cellular coverage. As shown in FIG. 2, UE 1 and UE 2 are able to communication directly via the PC5 interface. In sidelink communication, a UE transmits data to another UE may be referred to as a TX UE, and a UE receives data from another UE may be referred to as an RX UE, a destination UE, or a destination. For example, if UE 1 transmits sidelink data to UE 2, then UE 1 is the TX UE and UE 2 is the RX UE.

A UE involved with sidelink communication first needs to select a transmission resource for transmitting sidelink data to a peer UE (i.e., RX UE). The transmission resource (may also be referred to as resource for simplicity) occupies both time domain resource and frequency domain resource. The UE may transmit sidelink data using the transmission resource in a transmission occasion. Specifically, the UE may be configured with a resource pool including multiple transmission resources which may serve as candidate resources. For example, a base station may configure the resource pool for the UE; the UE may solicit preferred transmission resources and/or non-preferred transmission resources from neighbor UEs in order to create or update its transmission resource pool; the UE may also deploy a sensing mechanism to learn resource utilization information from other neighboring UEs; other resource discovery mechanisms may further be deployed by the UE. In sidelink, there are various mechanisms for supporting transmission resource selection, among these mechanisms are:

### Transmission Mode 1

A serving base station specifies the transmission resources via a Downlink Control Indicator (DCI) message (e.g., a DCI format 5) sent to the TX UE. This mode requires the TX UE to be under cellular coverage, and may further require the TX UE to be in a connected state.

### Transmission Mode 2

The TX UE self-selects the transmission resources according to predefined rules aimed at minimizing the collision risk. This mode can be used when the UE is connected, idle, or out of coverage.

### Transmission Sub-Mode 2a

Each UE autonomously selects its transmission resources.

### Transmission Sub-Mode 2b

UEs assist other UEs in performing transmission resource selection. The UE providing assistance may be the RX UE, which may notify the TX UE with its preferred or non-preferred resources. The UE assisting other UEs may be referred to as UE-A, and assisted UE may be referred to as UE-B. The UE-B may request assistance information for transmission resource selection from a UE-A via an inter-UE coordination process. Specifically, the UE-B may send an inter-UE coordination request to the UE-A when certain conditions are met, for example, when a periodical timer expires, or when the assistance information is considered to be stale. The assistance information may be categorized in three types:
Type-A: transmission resources preferred by UE A.
Type-B: transmission resources not preferred by UE A.
Type-C: transmission resources with collision detected by UE A.

It is to be understood that once UE-B receives type-B or type-C assistance information, the UE-B may derive non type-B or non type-C transmission resources correspondingly, for example, from its configured resource pool.

In some embodiments, when selecting the transmission resource, UE may consider a size and priority of the data to be transmitted using sidelink. During a sidelink data transmission session, the UE may have multiple data packets which need to be transmitted in multiple transmission occasions. The UE may pre-select transmission resources for each of the transmission. The transmission occasion may be periodic, for example, every 2 seconds. As an example, the UE may transmit data packet 1 in the first transmission occasion, and data packet 2 in the second transmission occasion, which is 2 seconds away from the first transmission occasion. In another example, the UE may pre-select 10 transmission occasions with a periodicity of 3 seconds. Depending on the availability of data to be transmitted, the UE may use all of these 10 transmission occasions, or skip some of the transmission occasions if there is no data need to be transmitted during these transmission occasions.

In some embodiments, the UE may select a transmission resource for the first sidelink data packet, then select transmission resources for subsequent data packets.

The UE may also select transmission resource for data re-transmission, to be used if the initial data transmission fails.

In the sidelink communication, the UE may also transmit control signal, which may be referred to as sidelink control information (SCI) message, via the Physical Sidelink Control Channel (PSCCH) to a peer UE. The SCI may be used to describe the dynamic transmission properties of the Physical Sidelink Shared Channel (PSSCH) that follows it.

### Brief Description of Embodiments

In this disclosure, various embodiments are disclosed to solve various issues or provide further improvement to sidelink communication. These embodiments cover various aspect of the sidelink communication, such as:
Sidelink transmission resource selection in DRX mode;
Sidelink transmission resource selection/re-selection;
Inter-UE coordination for transmission resource selection;
Logical channel prioritization; and
Assisting information reporting via shared transmission resource.

### Embodiment 1: Resource Selection Under DRX

Currently, in sidelink communication, there is no mechanism for UEs to negotiate a time window for sidelink data transmission. A UE may need to continuously monitor its data reception channel for assisting its sidelink data transmission resource selection, which leads to increased power consumption.

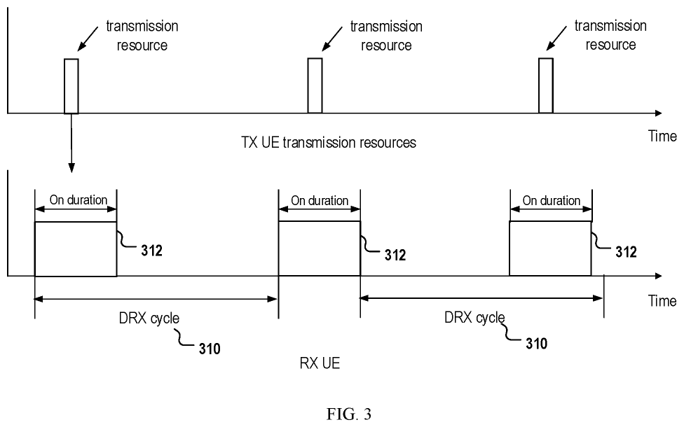

In this embodiment, a Discontinuous Reception (DRX) mechanism is introduced to the sidelink communication. FIG. 3 illustrates an exemplary DRX configuration. A UE receiving sidelink data (i.e., RX UE) is configured with DRX. In each DRX cycle 310, the RX UE wakes up and is in active state during the on duration 312. The RX UE then goes into sleep at rest of the DRX cycle 310 to conserve power. The RX UE may only receive sidelink data when it is active.

For the UE transmitting sidelink data (i.e., TX UE), as shown in FIG. 3, in some embodiments, the TX UE may select transmission resource which falls under the active time of the RX UE to ensure the RX UE is able to receive the sidelink data.

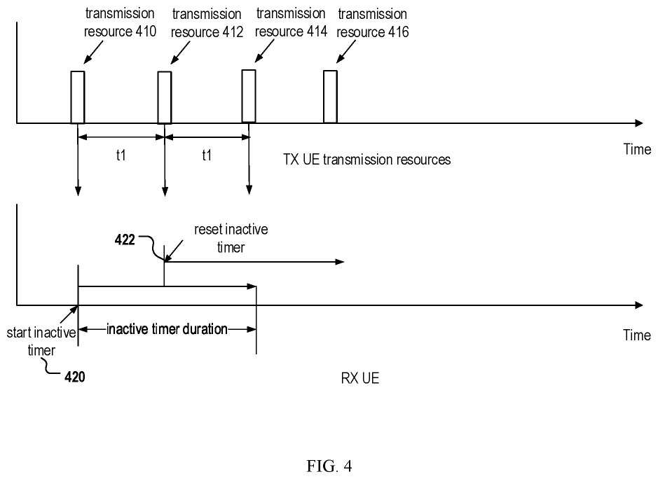

In some embodiments, on top of the DRX mechanism, the RX UE may further be configured with an inactive timer (or inactivity timer). Once the RX UE receives sidelink data, the inactive timer is started with a configurable timer duration, for example, 10 seconds. Then within the next 10 seconds, the RX stays active. Within these 10 seconds, if there is no data received, the RX UE may go back to sleep once the timer expires; if there is data received, the RX UE reset (i.e., restart) the inactive timer upon receiving data and stays active. Referring to FIG. 4, at 420, the RX UE receives a sidelink data packet, which is transmitted by the TX UE using the transmission resource 410. Upon receiving the sidelink data packet, the RX UE starts the inactive timer. Later at 422, the RX UE receives another data packet, which is transmitted by the TX UE using the transmission resource 412. The RX UE resets the inactive timer and stays active. The RX UE further receives another sidelink data packet corresponding to the transmission resource 414. As the inactive timer is not expired, the RX UE is still active and is able to receive data. Similarly, not shown in FIG. 4, the RX UE resets the timer again.

The inactive timer described above is just for exemplary purpose. There may be other ways for checking and determining the active time of a UE, which is not limited in this disclosure.

Based on the description above, the TX UE may select transmission resource with consideration of the inactive timer configured on the RX UE to ensure the RX UE is active when the sidelink data is transmitted using the selected transmission resource. In some embodiments, the TX UE may follow steps below to select the transmission resource, with reference to FIG. 4.

### Step 1

The TX UE selects a transmission resource for the first sidelink data packet. The transmission resource falls within RX UE active time. For example, TX UE selects the transmission resource 410 to transmit the first sidelink data packet.

### Step 2

The TX UE selects transmission resources for subsequent sidelink data packets. The selection may follow a periodicity t1. The TX UE chooses a t1 value, such that t1 is less than or equal to the length of the inactive timer of the RX UE. For example, TX UE selects transmission resources 412, 414, and 416 to be used for subsequent sidelink data packets transmission. The selection of these transmission resources ensures that the RX UE is active when the sidelink data packet is transmitted, with the help of the inactive timer.

In some other embodiments, the TX UE may include in an SCI a set of transmission resources associated with a sidelink data transmission session and transmit the SCI to the RX UE. For example, the TX UE may indicate to the RX UE there are 4 transmission resources (e.g., 410, 412, 414, and 416) that the TX UE reserves or is expected to use. The RX UE may in turn adjust its active time, once it serves all the expected transmission resources. For example, after the RX UE serves the transmission resource 416, for example, after the RX UE receives the data carried in the transmission resource 416, it may no longer need to reset the inactive timer.

### Embodiment 2: Resource Selection

A TX UE may perform sidelink communication with multiple RX UEs. For example, the TX UE may have one unicast link (for sidelink) with RX UE 1, and another unicast link (for sidelink) with RX UE 2. In one scenario, RX UE 1 is running in DRX mode, however RX UE 2 is not running in DRX mode. In this case, RX UE 1 may go to sleep mode periodically while RX UE 2 may not go to sleep mode. Based on current sidelink implementation, the TX UE may select a transmission resource as far as any one of the destination UEs (i.e., RX UEs) is active for the transmission resource. Therefore, there is a probability that the TX UE selects a transmission resource which is suitable for RX UE 2, but not suitable for RX UE 1, as RX UE 1 may be in sleep mode for the selected transmission resource.

Various solutions are disclosed in this embodiment to cover transmission resource selection under the aforementioned scenario.

### Solution 1

During transmission resource selection, the TX UE first finds and selects logical channels which have data available to be sent by sidelink. For example, there are 10 logical channels and UE finds 6 of these logical channels have data available.

Among the 6 selected logical channels, the TX UE further selects a logical channel having the highest priority. The TX UE selects sidelink transmission resource based on the selected logical channel.

### Solution 2

During transmission resource selection, the TX UE first finds and selects logical channels which have a number of available token greater than 0. For example, there are 10 logical channels and UE finds 3 of these logical channels having a number of token greater than 0.

Among the 3 selected logical channels, the TX UE further selects a logical channel having the highest priority. The TX UE selects sidelink transmission resource based on the selected logical channel.

### Solution 2a

During transmission resource selection, the TX UE first finds and selects a logical channel which has the most tokens. The TX UE selects sidelink transmission resource based on the selected logical channel. Or the TX may rank the logical channels based on the token owned by each of the logical channels, and selects the top ranked n logical channels, where n is a non-negative integer.

### Solution 3

The TX UE is configured with a sidelink transmission resource pool (also referred to as resource pool for simplicity), which includes multiple transmission resources. The TX UE may rank these transmission resources based on the number of RX UEs a transmission resource is suitable for. For example, if a transmission resource does not fall into a period when an RX UE is active, then the transmission resource is not suitable for that particular RX UE. The more RX UEs a transmission resource is suitable for, the higher rank it is given. The TX UE may then select a transmission resource having the highest rank.

### Option 3a

If an active time of one specific destination does not overlap with any other destination, the TX UE may select the transmission resource within the active time of this specific destination separately, the transmission resource may be dedicated to the specific destination.

### Option 4

In some embodiments, different RX UEs may be configured with different DRX configurations, for example, different DRX cycles. The TX UE may divide these different DRX configurations into multiple sets. For example, a first set corresponds to a first DRX cycle range, and a second set corresponds to a second DRX cycle range. For each set of the DRX configurations, the TX UE may configure a corresponding sidelink communication configuration. The sidelink communication configuration may include at least one of a Data Radio Bearer (DRB) configuration, or a logical channel configuration.

In some embodiments, the TX UE may configure one sidelink communication configuration applies to destinations with DRX disabled, and another sidelink communication configuration applies to destinations with DRX enabled.

### Option 5

The TX UE may select or configure a set of transmission resource for each destination.

### Embodiment 3: Resource Reselection

The TX UE may pre-select transmission resources for a future sidelink data transmission. For example, referring to FIG. 4, the TX UE may pre-select transmission resources 412, 414, and 416 when it selects transmission resource 410. Under certain condition, the TX UE may later determines a pre-selected transmission resource is no longer suitable for sidelink data transmission, for example, if the RX UE is not active for the pre-selected transmission resource. In this case, the TX UE may trigger a transmission resource re-selection.

In another scenario, the TX UE may estimate or evaluate whether the RX UE is active, for example, by checking an inactive timer or a re-transmission timer. However, under certain conditions, the estimation or evaluation based on these timers may not be accurate. For example, if no sidelink data is transmitted in a transmission occasion, referring to FIG. 4, if no data is transmitted in transmission resources 414, then the inactive timer of the RX UE may not be reset, which may cause the RX UE go into non-active state for transmission resources 416, so transmission resources 416 is no longer suitable for the RX UE. In another example, the SCI carrying control information may be blocked or not transmitted to the RX UE due to intra-UE prioritization which causes the estimation based on re-transmission timer to be not viable. In this scenario, the TX UE has two options:

### Option 1

The TX UE may trigger a transmission resource re-selection.

### Option 2

The TX UE may remove the non-suitable resource, select another resource to replace the non-available resource by the newly selected resource in the resource pool.

### Embodiment 4: Destination Selection

In sidelink communication, a TX UE performs logical channel prioritization (LCP) procedure in order to meet a priority requirement of each logical channel. When a destination (or RX UE) is running in DRX mode, the TX UE may determine whether the destination is active. During the LCP procedure, if the destination is not active, then this particular destination is skipped and the logical channel associated with the inactive destination is not served. In other words, the TX UE may only consider the logical channel when its associated destination is active during the LCP procedure.

### Embodiment 5: TX UE Inter-UE Coordination Initiation

As described earlier, in sidelink communication, an assisting UE (i.e., UE-A) may assist another UE for selecting transmission resources. The UE-A may send a set of resources to the assisted UE (i.e., UE-B). A TX UE may initiate a request to peer UE to solicit transmission resource information, that is, the TX UE may initiate an inter-UE coordination request.

If the TX UE makes the inter-UE coordination request too frequently, it may cause excessive traffic and other overhead between the UEs, and the coordination is un-necessary if the previously acquired resource information is still valid. On the other hand, if the TX UE waits for too long to initiate the coordination request, the previously acquired resource information may become stale, which may slow down the resource selection process and lead to sidelink data transmission delay.

In this embodiment, various conditions are disclosed such that when one or more of these conditions are satisfied, the TX UE initiates the inter-UE coordination request. These conditions include:
When the sidelink data to be transmitted has a priority or reliability requirement which is higher than a configured threshold.
When a Channel Busy Ratio (CBR) of the TX UE is higher than a configured threshold.
A number of discontinuous transmission to the UE-A is higher than a configured threshold.
A number of Hybrid Automatic Repeat Request Negative Acknowledgement (HARQ NACK) received from the UE-A is higher than a configured threshold.
A peer UE supports inter-UE coordination.
Sidelink data, for a logical channel associated with a destination (e.g., an RX UE), becomes available to the MAC entity of the TX UE; and either this sidelink data belongs to a logical channel with higher priority than the priorities of the logical channels containing available sidelink data which belong to any LCG (LC group) belonging to the same destination (same RX UE); or none of the logical channels which belong to an Logical Channel Group (LCG) belonging to the same Destination contains any available sidelink data.
When a periodic timer for inter-UE coordination expires. For example, the TX UE maintains a timer, such that once the timer expires, the TX UE sends the inter-UE coordination request and at the mean time start or restart the timer.
If the TX UE receives no reply for an inter-UE coordination request. For example, the TX UE may start another timer once an inter-UE coordination request is transmitted to a UE-A. Once the timer expires, TX UE retransmits the inter-UE coordination request, and the TX UE stops the timer once TX UE receives the assistance information from UE-A. In another embodiment, the UE is configured with a retransmission number threshold, if the number of request retransmission reaches the threshold, the TX UE considers the UE-A to be unavailable. In this case, the TX UE may trigger a UE-A re-selection procedure.
A set of resource provided by UE-A is out of date. For example, the TX UE (acts as UE-B) has a keep fresh timer and the timer is started or reset once the TX UE receives a new set of resources from UE-A. When the timer expires, the TX UE considers the set of resource to be out of date.
When the resources in the set of resources provided by UE-A is consumed. For example, the TX UE may maintain a counter with a predefined initial value and the counter is decremented each time a resource from the resource set is selected. Once the counter reaches 0 (or another predefined value), an inter-UE coordination request is triggered. In some embodiments, once the counter reaches 0 (or another predefined value), the TX UE may randomly select a value from an interval [0, 1] with equal probability. If the selected value is above a configured threshold, the TX UE may trigger an inter-UE coordination request.
When the sidelink transmission resource pool of the UE, or sensing parameters of the UE is re-configured.
If there is no resource selected from the transmission resource pool, or there is no suitable resource in the resource pool for a sidelink transmission.
If the TX UE does not reference or select the resource indicated by UE-A for selecting the transmission resource during the last (i.e., previous) N seconds, where N is an integer.
If the number of consecutive unused transmission opportunities on resources indicated by UE-A is equal to a predefined value (e.g., sl-ReselectAfter).
If no transmission resource in the set of transmission resources provided by the UE-A can accommodate a maximum allowed Modulation Coding Scheme configured in the TX UE.
If no transmission resource in the set of transmission resources provided by the UE-A can satisfy a latency requirement of a sidelink data transmission.
If the TX UE acting as UE-B determines that the resource sensed by itself has no overlap with type-A resource provided by UE-A. Or an overlap ratio is less than a configured threshold. For example, if 5 out 10 resources sensed by the TX UE overlaps with the type-A resource, then the overlap ratio is 50%.
If the TX UE acting as UE-B determines that all resources sensed by itself overlap with type-B or type-C resource provided by UE-A. Or an overlap ratio between the self-sensed resource and type-B or type-C resource is bigger than a configured threshold.

In some embodiments, the TX UE acting as UE-B may consider the set of resource provided by the UE-A to be out of date if any one of above conditions is met.

In some embodiments, considering that there is a time gap between transmitting the inter-UE coordination request and receiving the response from UE-A, UE-B may still use the resource provided by UE-A during the time gap. Specifically, after UE-B sends the inter-UE coordination request, UE-B may start a timer, and if the timer is running, UE-B may consider that the set of resource provided by UE-A is available. UE-B stops the timer if a response including a new set of resource is received from UE-A.

The sensing parameters may be used by UE-A which may include:
the value of SL_RESOURCE_RESELECTION_COUNTER;
the number of sub-channels;
the resource reservation interval;
The Service Priority;
The pre-emption priority;
Indication of whether The pre-emption is enable or disable;
Packet Delay Budget;
HARQ feedback configuration (indicate whether UE-A need sensing resource pool with PSFCH resource);
Sensing window, defined by a timer interval;
Candidate resource selection window defined by a timer interval;
Bit map of slot in candidate Resource selection window that UE-A need to sensing (for partial sensing);
Values that are allowed for the signaling of the resource reservation period;
RSRP threshold;
Reference signal: PSSCH-RSRP or PSCCH-RSRP;
Percentage of candidate single-slot resources remaining in the candidate resource set;
Step of RSRP-threshold increment; and
Resource pool related configuration.

It is to be understood that the thresholds, parameters, or counters in this disclosure may be configured based on practical need by a person skilled in the art, which may be configured per priority, per destination, per Quality of Service (QoS) requirement, or per service type. The configuration may be performed by the network via broadcast message (e.g., Master Information Block (MIB), System Information (SI)), Radio Resource Control (RRC) message, and the like.

In some embodiments, if Radio Link Failure (RLF) is triggered on UE-A, UE-B may consider the set of resource provided by UE-A to be out of date.

In some embodiments, if the connection between UE-A and UE-B is released or becomes unavailable, UE-B may consider the set of resource provided by UE-A to be out of date.

In some embodiments, a UE-B may further include a triggering condition in the inter-UE coordination request to the UE-A, so the UE-A may be aware of the reason why this inter-UE coordination request is sent. Correspondingly, UE-A may make adjustment when collecting and reporting assisting information to UE-B. For example, the UE-A may adjust a Reference Signal Received Power (RSRP) threshold, a Reference Signal Received Quality (RSRQ) threshold, or the like, when collecting transmission resource information to be sent to UE-B.

In some embodiments, if one of following conditions is met:
UE-B determines that the resource sensed by itself has no overlap with type-A resource provided by UE-A. Or an overlap ratio is less than a configured threshold.
UE-B determines that the resources sensed by itself all overlap with type-B or type-C resource provided by UE-A. Or an overlap ratio is higher than a configured threshold.

The UE-B may indicate its physical layer to re-sense the resource. The UE-B may also stop at least one of a timer which is associated with the inter-UE coordination request to this particular UE-A.

### Embodiment 6: Resource Selection and LCP for Mode 2b

A UE-B may select transmission resource by taking the set of resource provided by UE-A into consideration. If the set of resource is out of date, UE-B may not consider the set of resource.

In some embodiments, if there is type-A resource provided by UE-A, the UE-B may prefer type-A resource during resource selection when selecting resource for UE-A. If there is type-B or type-C resource provided by UE-A, UE-B may prefer non type-B or non type-C resource during resource selection.

In some embodiments, if there is type-A resource provided by UE-A and if the provided resource is not out of date, the UE-B may prefer type-A resource during resource selection. If there is type-B or type-C resource provided by UE-A, and if the resource is not out of date, UE-B may prefer non type-B or non type-C resource during resource selection.

In some embodiments, UE-B may have unicast links with multiple RX UEs. Among these RX UEs, one RX UE is capable of providing assistance information (i.e., acting as UE-A), whereas others are not. In other words, one RX UE acting as UE-A indicates to the UE-B with type-A resources that the RX UE prefers the UE-B to use when communicate with it. Other RX UEs do not have this preference or limitation. As such, UE-B may select transmission resource from the whole resource pool and there is a high probability that UE-B does not select the type-A resource provided and preferred by the RX UE acting as UE-A. To solve this issue, UE-B has following options:
When making transmission resource selection, UE-B prefers (or considers with higher priority) type-A, non type-B, or non type-C resources. In case there are assistance information provided by multiple UE-As, UE-B prefers the resource with the most overlap among these assistance information. Furthermore, if UE-B performs resource sensing and has self-sensed resource, UE-B prefers the resource with the most overlap among these assistance information and the self-sensed resource.
If type-A, non type-B, or non type-C resource provided by a specific UE-A has no overlap with any other set of resources provided by other UE-A or the resource sensed by UE-B itself, UE-B may select transmission resource for the specific UE-A separately.
The UE-B may select a set of resources for each UE-A, based on the assistance information provided by the each UE-A.

In some embodiments, if UE-A only provides a limited type-A resources to UE-B, for example, if the number of type-A resources is less than a threshold, the network can increase the priority of this UE-A so that sidelink data transmitted to UE-A may obtain more opportunities to be transmitted.

In some embodiments, a UE may be configured with multiple sets of sidelink configuration. The sidelink configuration may include DRB configuration and LCH configuration. One set may be used for destination UEs which have the inter-UE coordination capability enabled, and another set may be used for destination UEs which do not have the inter-UE coordination capability enabled or do not support inter-UE coordination.

In some embodiments, there are multiple types of inter-UE coordination, corresponding to the type of assistance information provided by UE-A, whether it is type-A, type-B, or type-C resource information. A UE may be configured with multiple sets of sidelink configuration each corresponds to a type of inter-UE coordination.

In some embodiments, a UE may be configured with multiple sets of sidelink configuration, based on a ratio or a ratio range between the number of type-A resources provided by UE-A and the total number of resources in the transmission resource pool. For example, if there are 100 transmission resources in the transmission resource pool, and 20 of these transmission resources overlap with the type-A transmission resource provided by UE-A, then the ratio is 20%. The UE may select a sidelink configuration for destination UE-A based on the ratio.

When the UE is performing the LCP procedure, or when the UE is performing mode 2b sidelink resource selection, the TX UE may select a destination UE (RX UE) under one of these conditions:
The selected sidelink transmission resource is in the set of preferred resources (type-A) provided by the UE-A;
The selected sidelink transmission resource is not in the set of not preferred resources (type-B) provided by the UE-A; or
The selected sidelink transmission resource is not in the set of collide resources (type-C provided by the UE-A.

In some embodiments, there is a prerequisite for the conditions above that the selected resource is not out of date, or the resource selection is based on resources which are not out of date.

In some embodiments, a UE-A may only be able to provide assistance resource selection information applies to itself In this case, the UE-B only considers the provided assistance resource selection information when selecting resource for this particular UE-A. In some other embodiments, a UE-A is capable of providing assistance resource selection information applies to itself and a set of other UEs, then the UE-B considers the provided assistance resource selection information when selecting resource for this particular UE-A and the set of other UEs.

### Embodiment 7: UE-A Sends Resource Report

The UE-A may report a set of resource by using Medium Access Control-Control Element (MAC CE). When performing the LCP procedure, if there are remaining bits (or capacity) after data multiplexing in the transmission resource, instead of ignoring or wasting the remaining capacity, the UE-A may use the remaining bits to report the set of resource, if the remaining capacity is enough to hold the MAC CE for the report.

Specifically, the UE-A may use the remaining capacity after data multiplexing if one of following condition are met.
If the size of this MAC CE is fixed, the remaining bit after data multiplexing is larger than the size of MAC CE plus its subheader; or
If the size of this MAC CE is not fixed, the size of MAC CE depends on the number of resources within the MAC CE, the remaining bits after data multiplexing is larger than the minimum size of MAC CE plus its subheader.

The description and examples in this disclosure are made from the network (e.g., base station) perspective, or from the UE perspective. It is to be understood that the network and the UE operate in a coordinated manner. The principle applies to the network side also applies to the UE side. For example, when the network transmits the WUB to the UE, the underlying principle for the transmission also applies to the reception of the WUB on the UE side.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for sidelink communication in a wireless communication network, performed by a first UE, comprising:
initiating a sidelink data transmission session with a second UE which is running in a Discontinuous Reception (DRX) mode; and
selecting a first transmission resource within a first active time of the second UE for transmitting a first data packet of the sidelink data transmission session to the second UE.

2. The method of claim 1, further comprising:
selecting a second transmission resource within a second active time of the second UE for transmitting a subsequent data packet of the sidelink data transmission session to the second UE.

3. The method of claim 1, further comprising:
configuring the sidelink data transmission session with a periodicity t1, wherein t1 is equal to or less than a duration of an inactivity timer managed by the second UE, and wherein the inactivity timer is reset by the second UE in response to receiving a subsequent data packet of the sidelink data transmission session.

4. The method of claim 1, wherein the first UE is running in a DRX mode.

5. The method of claim 4, further comprising:
configuring a first logical channel configuration for supporting a first sidelink data transmission to a first destination UE which is running in a DRX mode; and
configuring a second logical channel configuration for supporting a second sidelink data transmission to a second destination UE which is not running in the DRX mode.

6. The method of claim 1, wherein selecting the first transmission resource comprises:
selecting the first transmission resource within the first active time of the second UE for transmitting the first data packet of the sidelink data transmission session to the second UE according to a DRX configuration of the second UE.

7-8. (canceled)

9. A method for sidelink communication in a wireless communication network, performed by a first UE configured with a pre-selected transmission resource in a transmission resource pool for supporting sidelink data transmission to a second UE, comprising:
determining that the pre-selected transmission resource is no longer suitable for sidelink data transmission; and
updating the pre-selected transmission resource with a transmission resource which is suitable for sidelink data transmission.

10. The method of claim 9, wherein:
determining that the pre-selected transmission resource is no longer suitable for sidelink data transmission comprises:
determining that the pre-selected transmission resource is no longer suitable for the sidelink data transmission in response to the pre-selected transmission resource being not within an active time of the second UE; and
updating the pre-selected transmission resource comprises one of:
triggering a sidelink transmission resource reselection procedure; or
selecting the transmission resource which is suitable for the sidelink data transmission and replacing the pre-selected transmission resource with the transmission resource in a transmission resource pool maintained by the first UE.

11-17. (canceled)

18. The method of claim 1, further comprising:
configuring a first logical channel configuration for supporting sidelink data transmissions to a first set of destination UEs running in DRX modes, and a DRX cycle of each of the first set of destination UEs is within a first range; and
configuring a second logical channel configuration for supporting sidelink data transmissions to a second set of destination UEs running in DRX modes, and a DRX cycle of each of the second set of destination UEs is within a second range.

19. The method of claim 1, wherein:
before initiating the sidelink data transmission session, the method further comprises:
transmitting, to the second UE, a sidelink control information (SCI) message, the SCI message comprising a set of transmission resources to be reserved by the second UE to support the sidelink data transmission session; and
selecting the first transmission resource within the first active time of the second UE comprises:
selecting the first transmission resource from the set of transmission resources.

20. The method of claim 1, wherein:
the sidelink data transmission session is associated with a set of logical channels; and
the method further comprises:
determining a logical channel from the set of logical channels based on a predefined condition.

21. The method of claim 20, wherein the predefined condition comprises one of:
the logical channel having a highest priority among all logical channels within the set of logical channels which have sidelink data available for transmission; or
the logical channel having a highest priority among all logical channels within the set of logical channels which have a number of token greater than 0.

22. A first device for sidelink communication in a wireless communication network, the first device comprising a memory for storing computer instructions and a processor in communication with the memory, wherein, when the processor executes the computer instructions, the processor is configured to cause the first device to:
initiating a sidelink data transmission session with a second device which is running in a Discontinuous Reception (DRX) mode; and
selecting a first transmission resource within a first active time of the second device for transmitting a first data packet of the sidelink data transmission session to the second device.

23. The first device of claim 22, wherein, when the processor executes the computer instructions, the processor is configured to further cause the first device to:
select a second transmission resource within a second active time of the second device for transmitting a subsequent data packet of the sidelink data transmission session to the second device.

24. The first device of claim 22, wherein, when the processor executes the computer instructions, the processor is configured to further cause the first device to:
configure the sidelink data transmission session with a periodicity t1, wherein t1 is equal to or less than a duration of an inactivity timer managed by the second device, and wherein the inactivity timer is reset by the second device in response to receiving a subsequent data packet of the sidelink data transmission session.

25. The first device of claim 22, wherein the first device is running in a DRX mode.

26. The first device of claim 25, wherein, when the processor executes the computer instructions, the processor is configured to further cause the first device to:
configure a first logical channel configuration for supporting a first sidelink data transmission to a first destination device which is running in a DRX mode; and
configure a second logical channel configuration for supporting a second sidelink data transmission to a second destination device which is not running in the DRX mode.

27. A device comprising one or more processors, wherein the one or more processors are configured to implement a method of claim 9.

28. A computer program product comprising a non-transitory computer-readable program medium with computer code stored thereupon, the computer code, when executed by one or more processors, causing the one or more processors to implement a method of claim 1.

29. A computer program product comprising a non-transitory computer-readable program medium with computer code stored thereupon, the computer code, when executed by one or more processors, causing the one or more processors to implement a method of claim 9.
